(19) United States
(12) Patent Application Publication
(10) Pub. No.: US 2005/0144843 A1
(43) Pub. Date: Jul. 7, 2005

(54) Automatic plant watering device

(76) Inventor: Sheng-Huei Liao, Tali City (TW)

Correspondence Address: Dennison, Schultz, Dougherty & MacDonald, Suite 105, 1727 King Street, Alexandria, VA, 22314, US

(21) Appl. No.: 10/747,107

(22) Filed: Dec. 30, 2003

(51) Int. Cl. A01G 27/02

(52) U.S. Cl. 47/79

(57) ABSTRACT

An automatic plant watering device has a body that has multiple surfaces, multiple permeable elements and a cap. The body has multiple through holes defined through one of the surfaces and an opening defined in the body. The permeable elements are mounted respectively in the through holes. The cap is mounted on the opening in the body.

### BACKGROUND OF THE INVENTION

1. Field of Invention

The present invention relates to a plant watering device, and more particularly to an automatic plant watering device.

2. Description of the Related Art

A potted plant must be watered and fertilized regularly to keep the plant from dying. However, modern life is so busy people sometimes forget to water plants, and the plants wilt for want of water. Some automatic plant watering devices have been designed to prevent the foregoing situation, but conventional automatic plant watering devices are often large and are used outdoor and are not suitable for the potted plants.

An automatic plant watering device in accordance with the present invention obviates or mitigates the aforementioned problems.

### SUMMARY OF THE INVENTION

The primary objective of the present invention is to provide an automatic plant watering device suitable for potted plants. The automatic plant watering device in accordance with the present invention has a body, multiple permeable elements and a cap. The body has multiple surfaces, multiple through holes defined through one of the surfaces and an opening defined in the body. One of the permeable elements is mounted inside the corresponding through hole. The cap is mounted on the opening in the body.

Other objectives, advantages and novel features of the invention will become more apparent from the following detailed description when taken in conjunction with the accompanying drawings.

### BRIEF DESCRIPTION OF THE DRAWINGS

FIG. 1 is an exploded operational perspective view of a first embodiment of an automatic plant watering device in accordance with the present invention being used with a potted plant;

FIG. 2 is an operational side plan view in partial section of the automatic plant watering device in FIG. 1;

FIG. 3 is an operational side plan view in partial section of a second embodiment of the automatic plant watering device in accordance with the present invention being used with a potted plant; and

FIG. 4 is an operational side plan view in partial section of a third embodiment of the automatic plant watering device in accordance with the present invention being used with a potted plant.

### DETAILED DESCRIPTION OF THE INVENTION

The automatic plant watering device in accordance with the present invention is used to water potted plants and has a body, multiple permeable elements and a cap. The body has a cavity with multiple surfaces and an opening. One of the surfaces has multiple through holes defined through the surface, and the permeable elements are mounted respectively over the through holes on the surface. The cap seals the opening in the body. The surface with the permeable elements mounted on the through holes is toward soil in which a plant is planted.

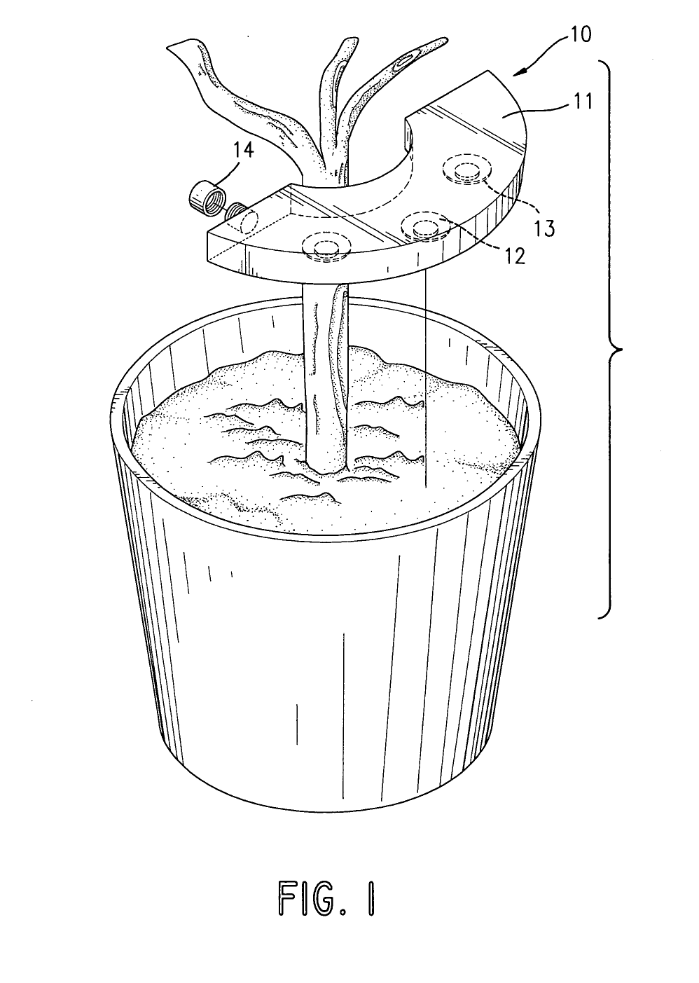

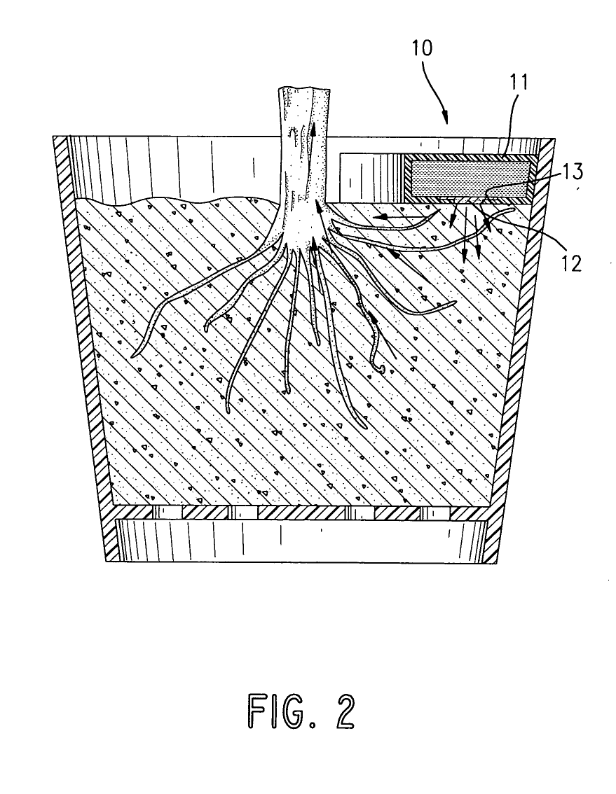

With reference to FIGS. 1 and 2, a first embodiment of an automatic plant watering device (10) in accordance with the present invention has a body (11), multiple permeable elements (12) and a cap (14).

The body (11) is arcuate and has a bottom surface (not numbered), two ends (not numbered), multiple through holes (13), multiple recesses (not numbered) and a threaded opening (not numbered). The through holes (13) are defined in the bottom surface of the body (11), and each recess is defined respectively around the through hole (13). The threaded opening is defined through one of the ends.

The permeable elements (12) are mounted respectively in the through holes (13), and each permeable element (12) has a lip (not numbered) mounted inside the corresponding recess of the through hole (13) and multiple capillary tubes (not shown).

The cap (14) is screwed onto the threaded opening to close opening in the end of the body (11).

When the automatic plant watering device (10) is used, the bottom surface of the body (11) lies on the soil of the potted plant. Because of the capillary tubes in the permeable elements (12), water inside the body (11) will be drawn from the body (11) into the soil of the potted plant.

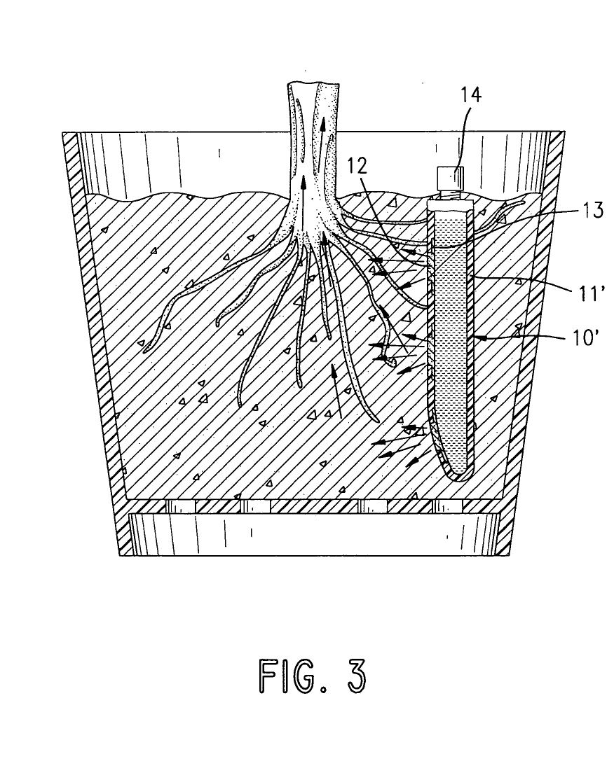

With reference to FIG. 3, a second embodiment of the automatic plant watering device (10′) is formed as cuboid and has a body (11′), multiple permeable elements (12) and a threaded opening (not numbered). The body (11′) has two side surfaces (not numbered) and multiple through holes (13) defined through one of the side surfaces of the body (11′). The permeable elements (12) are mounted respectively in the through holes (13). The entire body (11′) is inserted into the soil in a flowerpot with the side surface with the permeable elements (12) toward the roots of the potted plants. Transpiration in potted plants causes soil in a flowerpot to become drier which causes the soil to draw water through the permeable element into the flowerpot.

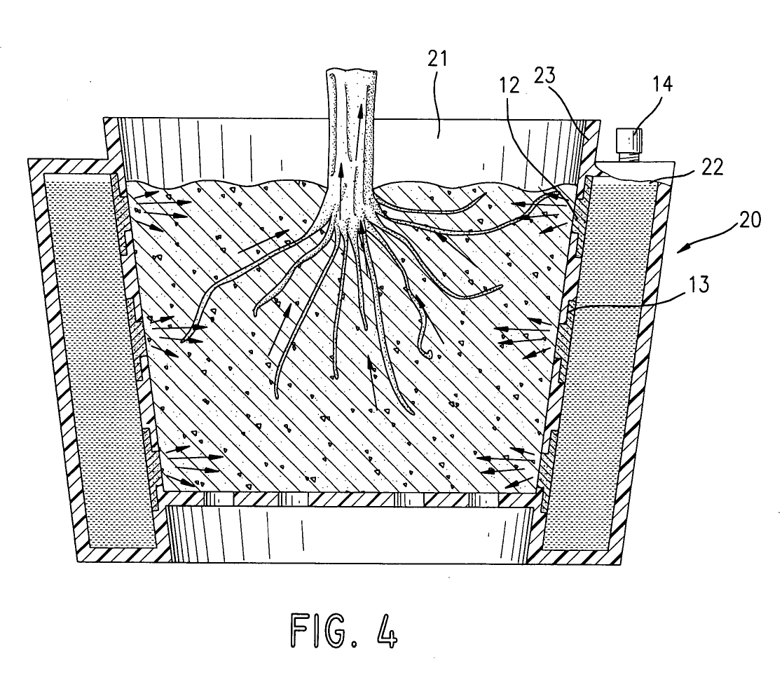

With reference to FIG. 4, a third embodiment of the automatic plant watering device (20) in accordance with the present invention has a body (not numbered), multiple permeable elements (12) and a cap (not numbered). The body is formed as a pot and has an inner surface (not numbered), an outer surface (not numbered), an inter pot (21), an outer cavity (22) and a threaded opening (not numbered). The inner surface is between the inner pot (21) and the outer cavity (22) and has multiple through holes (13). The through holes (13) and the permeable elements (12) mounted on the through holes (13) are the same as the first and second embodiment of the automatic plant watering device so further description is omitted as being redundant. The outer cavity (22) is a closed cavity and has two ends (not numbered) and a threaded opening (not numbered) formed on one of the ends. The threaded opening is defined in the outer cavity and the cap is mounted onto the threaded opening.

A potted plant is cultivated inside the inner pot (21), and water inside the outer cavity (22) can be drawn from the outer cavity (22) to the roots of the potted plant.

The automatic plant watering device in accordance with the present invention has the following advantages.

1. When the body (11, 11′) or the outer cavity (22) is full of water, the water can be drawn to the soil automatically through the permeable elements (12). Because of the capillary tubes, a user does not need to water the pot plant.

2. When fertilizer or a drug needs to be applied to a potted plant, the fertilizer or the drug can be dissolved in water inside the body (11, 11′) or the outer cavity (22) to extend the period of time during which the fertilizer or drug is applied.

The invention may be varied in many ways by a person skilled in the art. Such variations are not to be regarded as a departure from the spirit and scope of the invention, and all such modifications are intended to be included within the scope of the following claims.

1. An automatic plant watering device comprising
a body having
multiple surfaces, one of the surfaces having multiple through holes defined through the surface;
two ends; and
an opening formed on one end of the body and different from the surface through which the through holes are defined;
multiple permeable elements mounted respectively in the corresponding through holes in the surface, and
a cap mounted on the opening;
wherein the permeable elements mounted in the through holes are toward soil in which a plant is planted.

2. The automatic plant watering device as claimed in claim 1, wherein the body has
a bottom surface,
an inner surface,
two ends, and
multiple through holes defined in the bottom surface of the body, and
multiple recesses defined in the inner surface and respectively around the through holes,
the opening is defined through one of the ends, and
the permeable elements mounted respectively in the through holes and having
a lip mounted inside the corresponding recess in the through hole.

3. The automatic plant watering device as claimed in claim 2, wherein the body of the automatic watering device is arcuate.

4. The automatic watering device as claimed in claim 1, wherein the body has two side surfaces, each through hole is defined through one of the side surfaces of the body, wherein the automatic plant watering device is a cuboid.

5. The automatic plant watering as claimed in claim 1, wherein the body further comprises
an inter pot, an outer cavity, an inner plate between the inner pot and the outer cavity and having
an inner surface toward the outer cavity, and
multiple recesses defined in the inner surface and respectively around the through holes;
the through holes are defined through the inner surface;
each permeable element has a lip mounted inside a corresponding one of the recesses; and
the opening is defined in the body and communicates with the outer cavity.
